(19) United States
(12) Patent Application Publication
(10) Pub. No.: US 2016/0113060 A1
(43) Pub. Date: Apr. 21, 2016

(54) METHOD AND APPARATUS FOR MANAGING DEVICE INFORMATION FOR DEVICE-TO-DEVICE COMMUNICATION

(71) Applicant: Electronics and Telecommunications Research Institute, Daejeon (KR)

(72) Inventors: Eun Seon CHO, Daejeon (KR); Hyung-sub KIM, Daejeon (KR); YEON SEUNG SHIN, Daejeon (KR)

(21) Appl. No.: 14/728,015

(22) Filed: Jun. 2, 2015

(30) Foreign Application Priority Data
Oct. 20, 2014 (KR) 10-2014-0142055

(51) Int. Cl. H04W 76/06; H04W 4/00

(52) U.S. Cl. CPC H04W 76/064; H04W 4/005

(57) ABSTRACT

When receiving a detachment notification message informing of detachment of a first D2D device, a D2D server in a device-to-device (D2D) communication system performs a D2D communication release procedure of an opponent D2D device which is communicating with the first D2D device, and deletes information for the D2D communication of the opponent D2D device.

### CROSS-REFERENCE TO RELATED APPLICATION

This application claims priority to and the benefit of Korean Patent Application No. 10-2014-0142055 filed in the Korean Intellectual Property Office on Oct. 20, 2014, the entire contents of which are incorporated herein by reference.

### BACKGROUND OF THE INVENTION

(a) Field of the Invention

The present invention relates to a method and an apparatus for managing device information for device-to-device communication, and more particularly, to a method for managing information for an opponent device which is in a communication state with a detached device when any one of devices is detached during device-to-device communication.

(b) Description of the Related Art

Device-to-device communication (D2D) means a communication scheme of directly transmitting/receiving data between two adjacent devices without passing through a base station. That is, the two devices each are a source and a destination of data and perform communication.

The device-to-device communication may be performed by a communication scheme using an unlicensed band of a wireless local area network (WLAN), Bluetooth, etc., which are stated in IEEE 802.11, but may also be performed by a licensed band such as a cellular communication band. The device-to-device communication scheme using the unlicensed band may hardly provide planned and controlled services and may have rapidly deteriorating performance due to interference. On the other hand, the device-to-device communication which is operated under the environment in which inter-band or inter-system interference is controlled may support QoS, may increase frequency use efficiency using frequency reuse, and may increase a communication allowable range.

As the device-to-device communication, there are discovery services for determining an opponent device such as missing child prevention and a criminal approaching alarm, and D2D communication services for data communication such as image communication, individual broadcasting, and file transmission. The discovery service may include an open discovery service for advertising service and a restricted discovery service for determining a specific opponent.

In the device-to-device communication using the licensed band, for example, cellular communication, the base station allocates a communication link and a discovery channel required for device-to-device communication and internally manages information of the communication link and the discovery channel, thereby effectively performing the D2D discovery and setting and release of the D2D data communication.

When one device is detached during the D2D communication, the opponent device may not go on the D2D communication, and the base station may also support setting of abnormal D2D communication when the information of the detached device, in particular, the information of the opponent device which is a communication pair with the detached device, is not deleted. Therefore, when one device is detached during the D2D communication, a procedure for removing the information of the opponent device which is part of the communication pair with the detached device is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for managing device information for device-to-device communication for removing information of an opponent device forming a pair with a detached device in the device-to-device communication.

An exemplary embodiment of the present invention provides a method for managing device information for a D2D server in a device-to-device (D2D) communication system. The method for managing device information includes: receiving a detachment notification message informing of detachment of a first D2D device; performing a D2D communication release procedure of an opponent D2D device which is communicating with the first D2D device; and deleting information for the D2D communication of the opponent D2D device.

The D2D communication release procedure may include at least one of a D2D communication link release procedure and a discovery channel release procedure.

The performing of the D2D communication release procedure may include: requesting the opponent D2D device of the communication link release through a packet data network gateway (PGW); receiving a link release complete of the opponent D2D device through the PGW; transmitting a D2D data communication service end indication to the opponent D2D device; and receiving a response to the D2D data communication service end indication from the opponent D2D device.

The deleting may include removing communication link information of the opponent D2D device from a D2D link information table.

The performing of the D2D communication release procedure may include: requesting the opponent D2D device of a discovery channel release through the PGW; and receiving a discovery channel release complete of the opponent D2D device through the PGW.

The deleting may include removing the discovery channel information of the opponent D2D device from a discovery information table.

Another embodiment of the present invention provides a method for managing device information for a base station in a device-to-device (D2D) communication system. The method for managing device information includes: receiving a D2D communication release request of an opponent D2D device which forms a pair with a detached first D2D device through an MME; deleting information for the D2D communication of the opponent D2D device; and notifying the opponent D2D device of detachment of the first D2D device.

The method may further include: receiving a D2D communication release complete with the first D2D device from the opponent D2D device; and transmitting a D2D communication release complete of the opponent D2D device through the MME.

The D2D communication release request may include at least one of a D2D communication link release request and a discovery channel release request.

The receiving may include receiving a communication bearer deactivate request message requesting the communication link release through the MME, and the deleting may include deleting communication link information of the first D2D device and the set opponent D2D device.

The notifying may include transmitting a radio resource configuration message requesting the communication link release, and the opponent D2D device may recognize a detach of the first D2D device and D2D data communication by the radio resource configuration message.

The receiving may include receiving a discovery release message requesting a discovery channel release through the MME, and the deleting may include deleting discovery channel information of the opponent D2D device.

The notifying may include transmitting the radio resource configuration message requesting the discovery channel release, and the opponent D2D device may recognize the detachment of the first D2D device and stop discovery transmission/reception by the radio resource configuration message.

Yet another embodiment of the present invention provides an apparatus for managing device information for a D2D device in a device-to-device (D2D) communication system. The apparatus for managing device information includes a memory and a processor. The memory may store the information for the D2D device performing D2D communication. The processor may perform a D2D communication releasing procedure of an opponent D2D device which is communicating with a first D2D device and delete the information for the D2D communication of the D2D device from the memory, when the first D2D terminal performing the D2D communication is detached.

The D2D communication release procedure may include at least one of a D2D communication link release procedure and a discovery channel release procedure, and the information for the D2D communication may include at least one of D2D communication link information and discovery channel information.

The apparatus may further include a transceiver transmitting and receiving messages to and from the opponent D2D device for the D2D communication release procedure.

The apparatus may further include a transceiver transmitting and receiving messages to and from a packet data network gateway (PGW) for the D2D communication release procedure.

### BRIEF DESCRIPTION OF THE DRAWINGS

FIG. 1 is a diagram illustrating an example of a D2D communication system according to an exemplary embodiment of the present invention.

FIG. 2 is a diagram illustrating a processing procedure depending on detachment of a D2D device in the D2D communication system according to the exemplary embodiment of the present invention.

FIGS. 3A and 3B are flowcharts illustrating a processing method depending on detachment of a D2D device in a D2D server according to an exemplary embodiment of the present invention.

FIGS. 4 and 5 are flowcharts illustrating a processing method depending on detachment of a D2D device in a base station according to an exemplary embodiment of the present invention.

FIG. 6 is a diagram illustrating an apparatus for managing information for a D2D server according to an exemplary embodiment of the present invention.

FIG. 7 is a diagram illustrating an apparatus for managing information for a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Throughout the specification, a terminal may be called a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like, and may also include all or some of the functions of the MT, the MS, the AMS, the HR-MS, the SS, the PSS, the AT, the UE, and the like

Further, a base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as the base station, a relay node (RN) serving as the base station, an advanced relay station (RS) serving as the base station, a high reliability relay station (HR-RS) serving as the base station, small base stations (a femto base station (femto BS), a home node B (HNB), a home eNodeB (HeNB), a pico base station (pico BS), a metro base station (metro BS), a micro base station (micro BS), and the like), and the like, and may also include all or some of the functions of the ABS, the nodeB, the eNodeB, the AP, the RAS, the BTS, the MMR-BS, the RS, the RN, the ARS, the HR-RS, the small base stations, and the like.

Hereinafter, a method and an apparatus for managing device information for device-to-device communication according to an exemplary embodiment of the present invention will be described in detail with reference to the accompanying drawings.

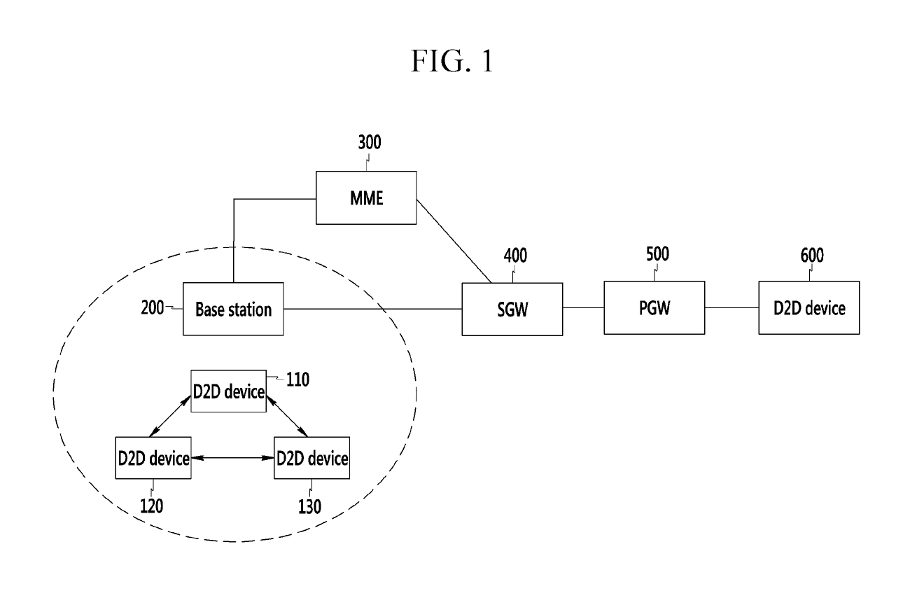

FIG. 1 is a diagram illustrating an example of a D2D communication system according to an exemplary embodiment of the present invention.

Referring to FIG. 1, a D2D communication system is based on a cellular network and includes a plurality of D2D devices 110, 120, and 130, a base station 200, a mobility management entity (MME) 300, a serving gateway (SGW) 400, a packet data network gateway (PGW) 500, and a D2D server 600.

The D2D devices 110, 120, and 130 are devices which may perform D2D communication with adjacent D2D devices. The D2D devices 110, 120, and 130 may be connected to one another via a physical channel, for example, a D2D communication link. The D2D devices 110, 120, and 130 may be connected to the base station 100 via a cellular physical channel. The D2D devices 110, 120, and 130 perform communication with the base station 100 and the adjacent D2D devices via the physical channel allocated from the base station 100. The D2D communication is a scheme to support direct communication with physically proximate devices without passing through infrastructure such as the base station 100. For example, the devices 110 and 120 may be connected to each other through the D2D communication link to perform the D2D communication, and the devices 120 and 130 may be connected to each other through the D2D communication link to perform the D2D communication. The D2D communication may include discovery or data communication.

The base station 200 allocates resources required for communication among the D2D devices 110, 120, and 130, and manages the D2D information of the D2D devices 110, 120, and 130. The D2D information may include the information for the D2D data communication and the information for the discovery. The resource required for communication may include, for example, the D2D communication link for the D2D communication and the discovery channel for the discovery. For example, the base station 200 may allocate the discovery channel for restricted discovery to the D2D devices 110, 120, and 130, and the D2D devices 110, 120, and 130 may each use the allocated discovery channel to perform the discovery procedure. The information for the D2D data communication may include, for example, the two D2D devices performing the D2D communication, that is, communication link information allocated to a pair, radio network temporary identifier (RNTI) information of the D2D device, and the like. The information for the restricted discovery may include the discovery channel information and the RNTI information which are allocated to the D2D device performing the restricted discovery.

When any one D2D device which is performing the D2D communication is detached, the base station 200 may delete the D2D information of the opponent D2D device which forms a pair with the detached D2D device to perform normal D2D communication setting.

When a connection between the D2D devices for performing the D2D communication is set, the base station 200 registers the D2D information of the D2D devices forming a pair for the D2D communication in a D2D server 600.

The MME 300 is an apparatus which serves to perform various kinds of control functions, and one MME 300 may be connected to the plurality of base stations 200.

The SGW 400 is an apparatus which provides a data bearer and generates or removes a data bearer depending on the control of the MME 300.

The PGW 500 controls the SGW 400 and performs a connection function of external networks such as Internet and the D2D server 600.

The D2D server 600 manages the D2D information of the D2D devices 110, 120, and 130. The D2D server 600 includes a D2D link information table and a discovery information table. The D2D link information table includes the D2D communication link information which is allocated a pair performing the D2D data communication. The discovery information table includes the discovery channel information which is allocated to each D2D device 110, 120, and 130.

The D2D server 600 registers the corresponding information of the opponent D2D device forming a pair with each D2D device 110, 120, and 130 in the D2D link information table and the discovery information table, and deletes the corresponding information of the opponent D2D device forming a pair with the detached D2D device from the D2D link information table and the discovery information table.

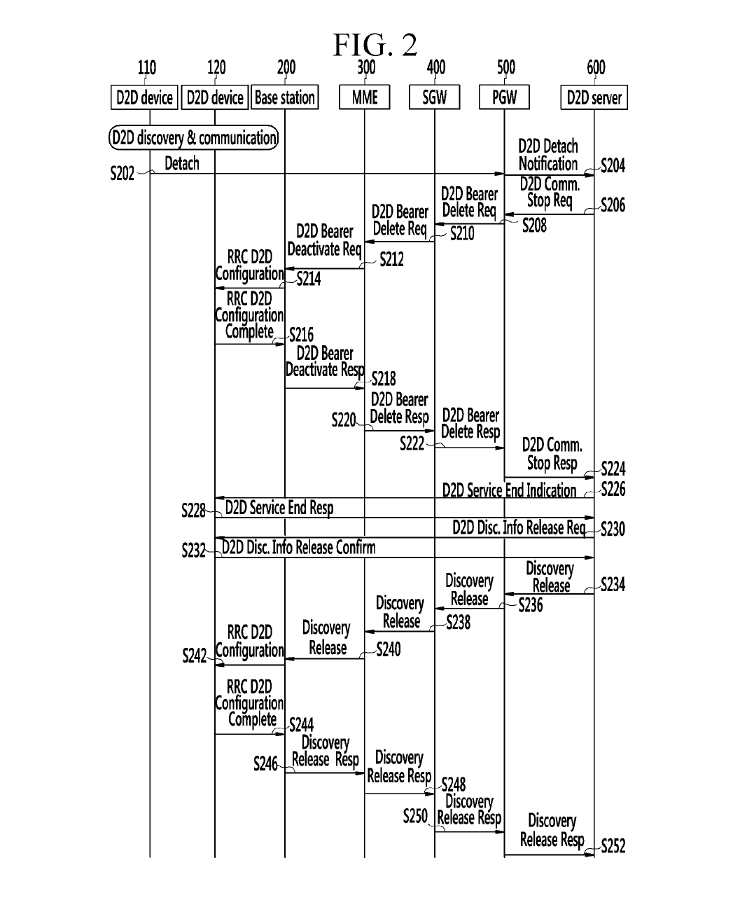

FIG. 2 is a diagram illustrating a processing procedure depending on detachment of a D2D device in the D2D communication system according to the exemplary embodiment of the present invention.

Referring to FIG. 2, it is assumed that the D2D device 110 is in the restricted discovery and communication state with the D2D device 120.

While the D2D device 110 transmits and receives a signal to and from the D2D device 120, the D2D device 110 performs the detachment procedure when being detached from the base station 200.

The D2D device 110 transmits a detachment message to the PGW 500 (S202).

When receiving the detachment message from the D2D device 110, the PGW 500 transmits a D2D detachment notification message to notify the D2D server 600 of the D2D device 110 (S204).

The D2D server 600 performs the D2D data communication release procedure of all the opponent D2D devices which are in the D2D data communication with the D2D device 110. The D2D server 600 may sequentially perform the D2D data communication release procedure on each opponent D2D device.

First, to release the D2D data communication of the D2D device 120, the D2D server 600 transmits the D2D communication stop request message to the PGW 500 (S206). The D2D communication stop request message may include identifier information of the D2D device 120 forming a pair with the detached D2D device 110. As the identifier information, the RNTI may be used.

The PGW 500 transmits a D2D bearer delete request message to the SGW 400 (S208). The D2D bearer delete request message may include the identifier information of the D2D devices 110 and 120.

The SGW 400 transmits the D2D bearer request message to a serving MME of the D2D device 120, for example, the MME 300 (S210).

The MME 300 transmits the D2D bearer deactivate request message to the serving base station of the D2D device 120, for example, the base station 200 (S212). The D2D bearer deactivate request message includes the identifier information of the D2D devices 110 and 120, and may be a message requesting the D2D communication link release.

The base station 200 deletes the information for the D2D data communication with the D2D information from the D2D information which is managed therein, and transmits a D2D radio resource configuration (RRC D2D configuration) message to the D2D device 120 to release the D2D communication link (S214).

When receiving the D2D radio resource configuration (RRC D2D configuration) message, the D2D device 120 recognizes the detachment of the D2D device 110 to stop the D2D communication with the D2D device 110 and releases the D2D communication link, and then transmits the D2D radio resource configuration complete (RRC D2D configuration complete) message to the base station 200 to notify the normal D2D communication link release (S216).

When receiving the D2D radio resource configuration complete (RRC D2D configuration complete) message from the D2D device 110, the base station 200 transmits the D2D bearer deactivate response message to the MME 300 (S218).

The MME 300 transmits a D2D bearer delete request message to the SGW 400 (S220).

The SGW 400 transmits a D2D bearer delete response message to the PGW 500 (S222).

The PGW 500 transmits the D2D communication stop response message to the D2D server 600 (S224).

Finally, the D2D server 600 receiving the D2D communication stop response message transmits the D2D service end indication message to the D2D device 120 to notify that the D2D data communication release procedure is completed (S226).

The D2D device 120 transmits the D2D service end response message to the D2D server 600 to respond to the completion of the D2D data communication release procedure (S228).

By the method, the D2D server 600 sequentially performs the D2D data communication release procedure of all the opponent D2D devices which are in the D2D communication state with the D2D device 110.

Next, the D2D server 600 performs the discovery channel release procedure on all the opponent D2D devices which are in the restricted discovery state with the D2D device 110. Similarly, the discovery channel release procedure may be sequentially performed on all the opponent D2D devices.

The D2D server 600 transmits the D2D discovery information release request message to the opponent D2D device 120 to notify the discovery channel release from the D2D device 110 (S230).

The D2D device 120 transmits the D2D discovery information release confirm message to the D2D server 600 to respond to the D2D discovery information release request message (S232).

The D2D server 600 transmits the discovery release message to the PGW 500 to release the discovery channel (S234). The discovery release message may include the identifier information of the detached D2D device 110 and the identifier information of the D2D device forming a pair with the detached D2D device 110.

The PGW 500 transmits the discovery release message to the SGW 400 (S236), and the SGW 400 transmits the discovery release message to the MME 300 (S238).

The MME 300 transmits the discovery release message to the base station 200 (S240), and the base station 200 deletes the discovery information of the D2D device 120 from the D2D information which is managed therein and transmits the D2D radio resource configuration message to the D2D device 120 to request the discovery channel release (S242).

When receiving the D2D radio resource configuration (RRC D2D configuration) message, the D2D device 120 recognizes the detachment of the D2D device 110 to stop transmitting/receiving the discovery to/from the D2D device 110 and releases the discovery channel, and then transmits the D2D radio resource configuration complete (RRC D2D configuration complete) message to the base station 120 and the base station 200 to notify the normal discovery channel release (S244).

The base station 200 transmits the discovery release response message to the MME 300 (S246).

The MME 300 transmits the discovery release response message to the SGW 400 (S248).

The SGW 400 transmits the discovery release response message to the PGW 500 (S250).

The PGW 500 transmits the discovery release response message to the D2D server 600 (S252).

Finally, the D2D server 600 receiving the discovery release response message completes the D2D data communication and discovery channel release procedure of the D2D device 120 which is the opponent device due to the detachment of the D2D device 110.

By this method, the D2D server 600 sequentially performs the discovery channel release procedure on all the opponent D2D devices which are in the discovery state with the D2D device 110.

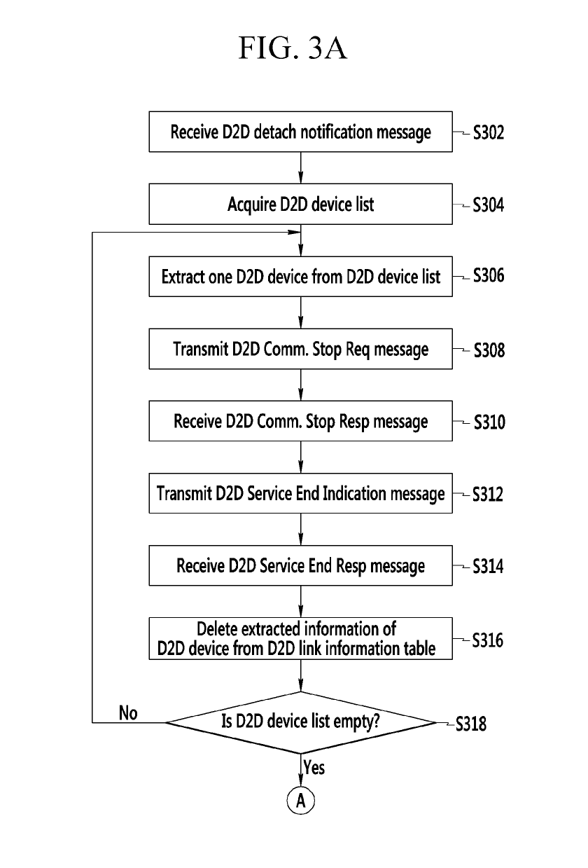

FIGS. 3A and 3B are each flowcharts illustrating a processing method depending on detachment of a D2D device in a D2D server according to an exemplary embodiment of the present invention.

Referring to FIG. 3A, when receiving the D2D detachment notification message of the D2D device 110 from the PGW 500 (S302), the D2D server 600 acquires a D2D device list on communication with the D2D device 110 from the D2D link information table which is managed by the D2D server 600 (S304). The D2D server 600 may extract the opponent D2D device which forms a pair with the D2D device 110 from the D2D link information table based on the identifier of the D2D device 110.

The D2D server 600 extracts one D2D device (for example, 120) from the D2D device list (S306).

The D2D server 600 transmits the D2D communication stop request message to the PGW 500 to release the communication link of the extracted D2D device 120 (S308). The D2D communication stop request message may include the identifier information of the D2D device 110 and the D2D device 120.

When receiving the D2D communication stop response message from the PGW 500 (S310), the D2D server 600 determines that the D2D communication link is successfully released and transmits the D2D service end indication message to the corresponding D2D device 120 (S312).

When receiving the D2D service end response message from the D2D device 120 (S314), the D2D server 600 deletes the information of the D2D device 120 from the D2D link information table (S316).

Next, the D2D server 600 confirms whether the D2D device list is empty (S318).

When the D2D device list is empty, the D2D server 600 extracts one D2D device from the D2D device list (S306) and repeats steps S308 to S316 to delete the information of the opponent D2D device which is communicating with the D2D device 110 from the D2D link information table.

The D2D server 600 repeats steps S306 to S316 until the D2D device list is empty.

Referring to FIG. 3B, if it determined that the D2D device list is empty, the D2D server 600 acquires a D2D discovery device list on performing discovery communication with the D2D device 110 from the discovery information table (S320).

The D2D server 600 extracts one D2D device 120 from the D2D discovery device list (S322).

The D2D server 600 transmits the D2D discovery information release request message to the D2D device 120 to notify the discovery channel of release of the extracted D2D device 120 (S324).

When receiving the D2D discovery information release confirm message from the D2D device 120 (S326), the D2D server 600 transmits the discovery release message to notify the PGW 500 of the discovery channel release of the D2D device 120 (S328).

When receiving the discovery release response message from the PGW 500 (S330), the D2D server 600 determines that the D2D discovery is successfully released and deletes the information of the D2D device 120 which is performing the discovery communication with the D2D device 110 from the discovery information table (S332).

Next, the D2D server 600 confirms whether the D2D discovery device list is empty (S334).

When the D2D discovery device list is not empty, the D2D server 600 extracts one D2D device from the D2D discovery device list (S322) and repeats steps S324 to S332 to delete the information of the opponent D2D device which is performing the discovery communication with the D2D device 110 from the discovery information table.

The D2D server 600 repeats steps S322 to S332 until the D2D discovery device list on performing the discovery communication with the D2D device 110 is empty.

When the D2D discovery device list is empty, the D2D server 600 completes and ends the D2D data communication and discovery channel release procedure of the opponent D2D device due to the detach of the D2D device 110 (S336).

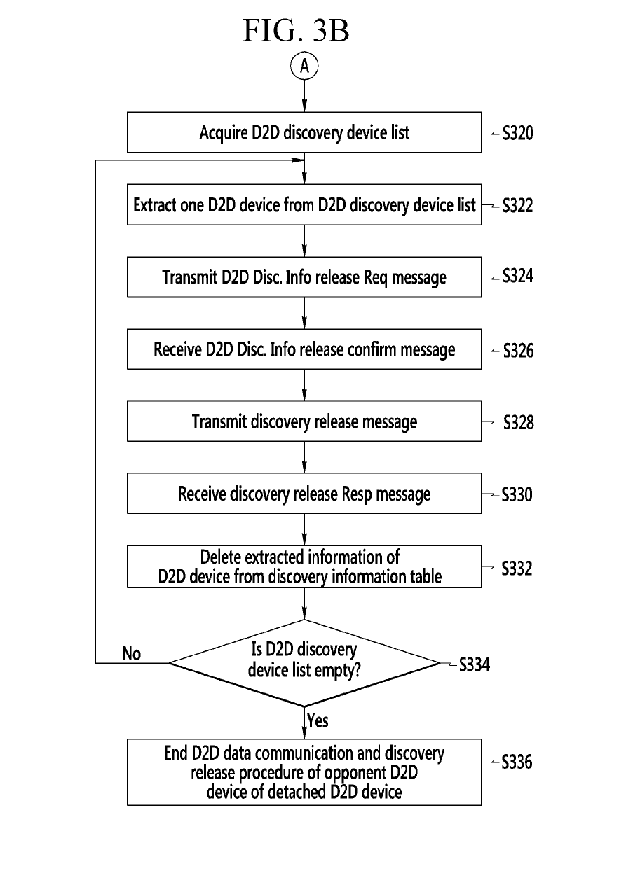

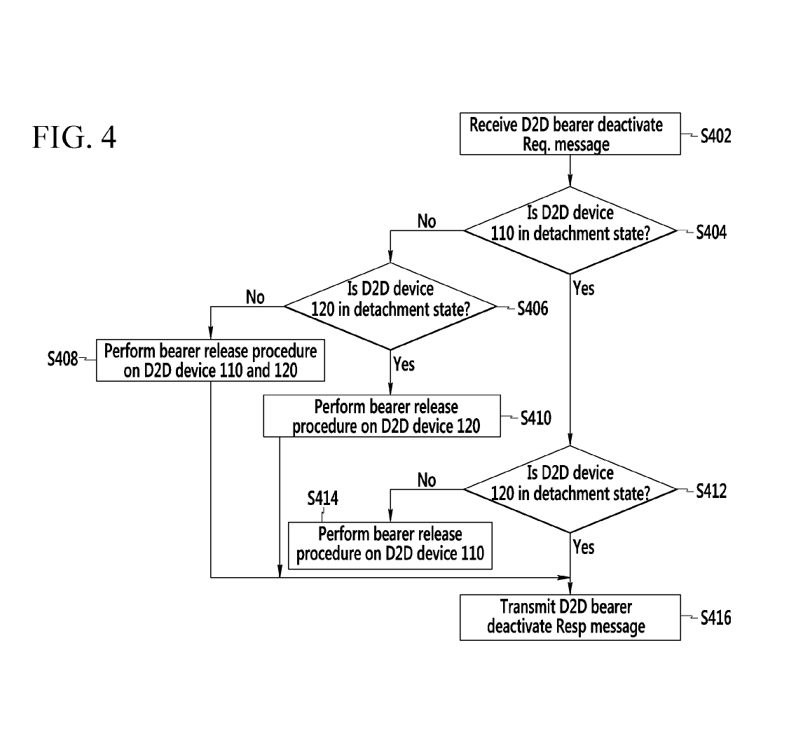

FIGS. 4 and 5 are each flowcharts illustrating a processing method depending on detachment of a D2D device in a base station according to an exemplary embodiment of the present invention.

Referring to FIG. 4, when receiving the D2D bearer deactivate request message from the MME 300 (S402), the base station 200 confirms whether the D2D device 110 is in a detachment state based on the identifier information of the D2D devices 110 and 120 within the D2D bearer deactivate request message (S404).

When the D2D device 110 is not in the detachment state, the base station 200 confirms whether the D2D device 120 is in the detachment state (S406).

When the D2D device 120 is not in the detachment state, the base station 200 performs the bearer release procedure on the D2D device 110 and the D2D device 120 (S408), deletes the information of the D2D device 110 and the D2D device 120, and then transmits the D2D bearer deactivate response message to the MME 300 (S416).

When the D2D device 110 is not in the detachment state and the D2D device 120 is in the detachment state, the base station 200 performs the bearer release procedure on the D2D device 110 (S410), deletes the information of the D2D device 110, and then transmits the D2D bearer deactivate response message to the MME 300 (S416).

When the D2D device 110 is in the detachment state, the base station 200 confirms whether the D2D device 120 is in the detachment state (S412).

When the D2D device 110 is in the detachment state and the D2D device 120 is not in the detachment state, the base station 200 performs the bearer release procedure on the D2D device 120 (S414), deletes the information of the D2D device 120, and then transmits the D2D bearer deactivate response message to the MME 300 (S416).

Meanwhile, when the D2D device 110 is in the detachment state and the D2D device 120 is in the detachment state, the base station 200 transmits the D2D bearer deactivate response message to the MME 300 (S416).

Referring to FIG. 5, when receiving the discovery release message from the MME 300 (S502), the base station 200 confirms whether the D2D is in the detachment state based on the identifier information of the D2D devices 110 and 120 in the discovery release message (S504).

When the D2D device 110 is not in the detachment state, the base station 200 confirms whether the D2D device 120 is in the detachment state (S506).

When the D2D device 120 is not in the detachment state, the base station 200 performs the restricted discovery channel release procedure on the D2D device 110 and the D2D device 120 (S508) and transmits the discovery release response message to the MME 300 (S516).

When the D2D device 110 is not in the detachment state and the D2D device 120 is in the detachment state, the base station 200 performs the restricted discovery channel release procedure on the D2D device 120 (S510) and transmits the discovery release response message to the MME 300 (S516).

When the D2D device 110 is in the detachment state, the base station 200 confirms whether the D2D device 120 is in the detachment state (S512).

When the D2D device 110 is in the detachment state and the D2D device 120 is not in the detachment state, the base station 200 performs the restricted discovery channel release procedure on the D2D device 110 (S514) and transmits the discovery release response message to the MME 300 (S516).

Meanwhile, when the D2D device 110 is in the detachment state and the D2D device 120 is in the detachment state, the base station 200 transmits the discovery release response message to the MME 300 (S516).

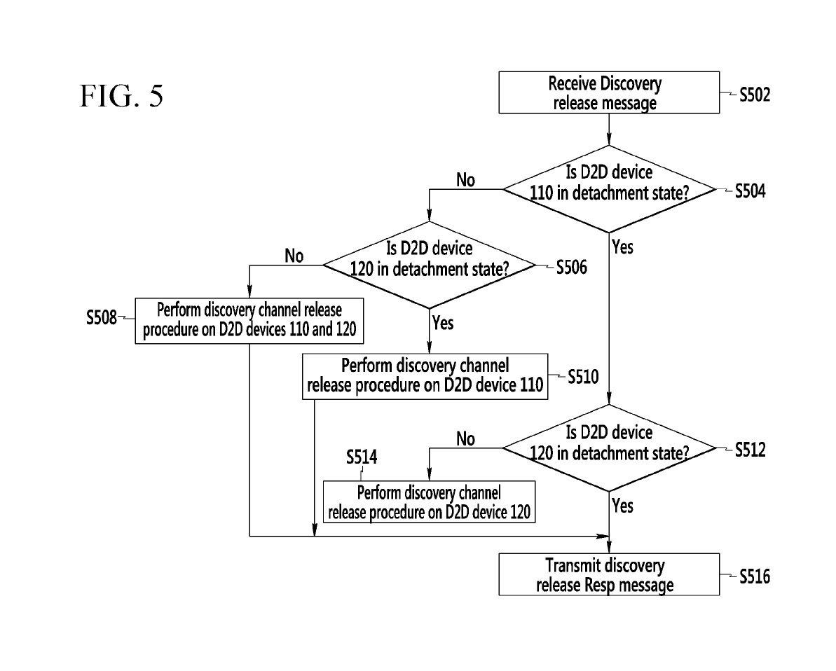

FIG. 6 is a diagram illustrating an apparatus for managing information for a D2D server according to an exemplary embodiment of the present invention.

Referring to FIG. 6, an apparatus 610 for managing information includes a processor 612, a transceiver 614, and a memory 616. The apparatus 610 for managing information may be included in the D2D server 600 or may be a D2D server 600 itself.

The processor 612 performs the D2D data communication and discovery channel release procedure described with reference to FIGS. 3A and 3B, and manages the information of the D2D link information table and the discovery information table which are stored in the memory 616. In particular, the processor 612 deletes the information of the opponent D2D device which is communicating with the detached D2D device during the D2D communication from the D2D link information table and the discovery information table.

The transceiver 614 performs a function of transmitting/receiving messages used in the D2D data communication and discovery channel release procedure.

The memory 616 stores instructions which are performed by the processor 612 or loads instructions from a separate storage (not illustrated) and temporarily stores the loaded instructions, and the processor 612 executes the instructions which are stored or loaded in the memory 616. Further, the memory 616 stores the information of the D2D link information table and discovery information table. The information of the D2D link information table and the discovery information table may be stored in the separate storage.

The processor 612 and the memory 616 are connected to each other through a bus (not illustrated), and an input/output interface (not illustrated) may be connected to the bus. In this case, the transceiver 614 is connected to the input/output interface and peripheral devices such as an input device, a display, a speaker, and a storage may be connected to the input/output interface.

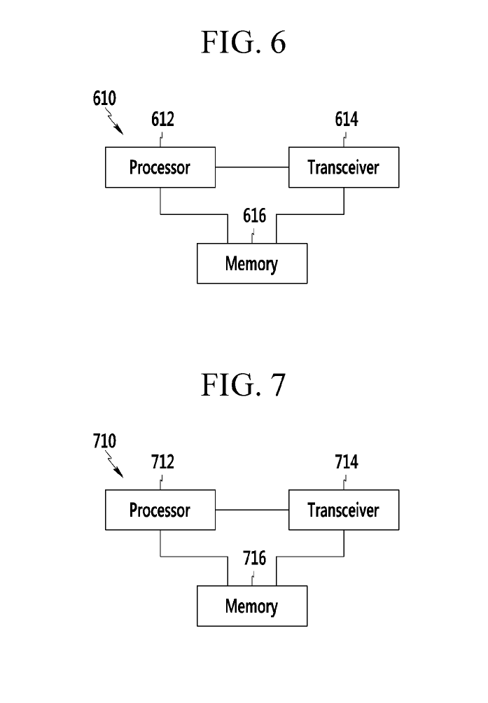

FIG. 7 is a diagram illustrating an apparatus for managing information for a base station according to an exemplary embodiment of the present invention.

Referring to FIG. 7, an apparatus 710 for managing information includes a processor 712, a transceiver 714, and a memory 716. The apparatus 710 for managing information may be included in the base station 200 or may be the base station 200 itself.

The processor 712 performs the D2D data communication and discovery channel release procedure described with reference to FIGS. 4 and 5, and manages the D2D information stored in the memory 716. In particular, the processor 712 deletes the information of the opponent D2D device which is communicating with the detached D2D device during the D2D communication from the D2D information which is managed.

The transceiver 714 performs a function of transmitting/receiving messages used in the D2D data communication and discovery channel release procedure.

The memory 716 stores instructions which are performed by the processor 712 or loads instructions from a separate storage (not illustrated) and temporarily stores the loaded instructions, and the processor 710 executes the instructions which are stored or loaded in the memory 716. Further, the memory 716 stores the D2D information. The D2D information may also be stored in the separate storage.

The processor 712 and the memory 716 are connected to each other through a bus (not illustrated), and an input/output interface (not illustrated) may be connected to the bus. In this case, the transceiver 714 is connected to the input/output interface and peripheral devices such as an input device, a display, a speaker, and a storage may be connected to the input/output interface.

According to an exemplary embodiment of the present invention, when one device among the devices during the direct communication within one cell is detached, correct operation of the system may be provided by the procedure for removing the information of the opponent device forming the pair with the detached device.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for managing device information for a D2D server in a device-to-device (D2D) communication system, comprising:
receiving a detach notification message informing of detachment of a first D2D device;
performing a D2D communication release procedure of an opponent D2D device which is communicating with the first D2D device; and
deleting information for the D2D communication of the opponent D2D device.

2. The method of claim 1, wherein the D2D communication release procedure includes at least one of a D2D communication link release procedure and a discovery channel release procedure.

3. The method of claim 1, wherein the performing of the D2D communication release procedure includes:
requesting the opponent D2D device of the communication link release through a packet data network gateway (PGW);
receiving a link release complete of the opponent D2D device through the PGW;
transmitting a D2D data communication service end indication to the opponent D2D device; and
receiving a response to the D2D data communication service end indication from the opponent D2D device.

4. The method of claim 3, wherein the deleting includes removing communication link information of the opponent D2D device from a D2D link information table.

5. The method of claim 1, wherein the performing of the D2D communication release procedure includes:
requesting the opponent D2D device of a discovery channel release through the PGW; and
receiving a discovery channel release complete of the opponent D2D device through the PGW.

6. The method of claim 5, wherein the deleting includes removing the discovery channel information of the opponent D2D device from a discovery information table.

7. A method for managing device information for a base station in a device-to-device (D2D) communication system, comprising:
receiving a D2D communication release request of an opponent D2D device which forms a pair with a detached first D2D device through an MME;
deleting information for the D2D communication of the opponent D2D device; and
notifying the opponent D2D device of detachment of the first D2D device.

8. The method of claim 7, further comprising:
receiving a D2D communication release complete with the first D2D device from the opponent D2D device; and
transmitting a D2D communication release complete of the opponent D2D device through the MME.

9. The method of claim 8, wherein the D2D communication release request includes at least one of a D2D communication link release request and a discovery channel release request.

10. The method of claim 7, wherein the receiving includes receiving a communication bearer deactivate request message requesting the communication link release through the MME, and the deleting includes deleting communication link information of the first D2D device and the set opponent D2D device.

11. The method of claim 10, wherein the notifying includes transmitting a radio resource configuration message requesting the communication link release, and the opponent D2D device recognizes detachment of the first D2D device and stops D2D data communication by the radio resource configuration message.

12. The method of claim 7, wherein the receiving includes receiving a discovery release message requesting a discovery channel release through the MME, and the deleting includes deleting discovery channel information of the opponent D2D device.

13. The method of claim 12, wherein the notifying includes transmitting the radio resource configuration message requesting the discovery channel release, and the opponent D2D device recognizes the detachment of the first D2D device and stops discovery transmission/reception by the radio resource configuration message.

14. An apparatus for managing device information for a D2D device in a device-to-device (D2D) communication system, comprising:
a memory storing the information for the D2D device performing D2D communication; and
a processor performing a D2D communication release procedure of an opponent D2D device which is communicating with a first D2D device and deleting the information for the D2D communication of the opponent D2D device from the memory, when the first D2D device performing the D2D communication is detached.

15. The apparatus of claim 14, wherein the D2D communication release procedure includes at least one of a D2D communication link release procedure and a discovery channel release procedure, and the information for the D2D communication includes at least one of D2D communication link information and discovery channel information.

16. The apparatus of claim 14, further comprising a transceiver transmitting and receiving messages to and from the opponent D2D device for the D2D communication release procedure.

17. The apparatus of claim 14, further comprising a transceiver transmitting and receiving messages to and from a packet data network gateway (PGW) for the D2D communication release procedure.
